(19) United States
(12) Patent Application Publication
(10) Pub. No.: US 2026/0229119 A1
(43) Pub. Date: Aug. 6, 2026

(54) INFORMATION PROVISION SYSTEM AND INFORMATION PROVIDING METHOD

(71) Applicant: TOYOTA JIDOSHA KABUSHIKI KAISHA, Toyota-shi (JP)

(72) Inventors: Kazuhito ESHIMA, Toyota-shi (JP); Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/447,088

(22) Filed: Jan. 13, 2026

(30) Foreign Application Priority Data
Feb. 3, 2025 (JP) 2025-016091

(51) Int. Cl. G08G 1/14; G06F 3/04847; G06Q 10/02

(52) U.S. Cl. CPC G08G 1/141; G06F 3/04847; G06Q 10/02

(57) ABSTRACT

An information provision system is applied to automated valet parking in a parking lot. The information provision system acquires vehicle management information including at least one of a record and a schedule of traveling and parking of each vehicle in the parking lot. The information provision system receives designation of a target time from a target user of a target vehicle. The information provision system generates, based on the vehicle management information, a bird's-eye view image showing a map of the parking lot and positions of the target vehicle and other vehicles in the parking lot at the target time with a bird's-eye view. The information provision system provides the target user with the bird's-eye view image.

### CROSS-REFERENCES TO RELATED APPLICATION

The present disclosure claims priority to Japanese Patent Application No. 2025-016091, filed on February 3, 2025, the contents of which application are incorporated herein by reference in their entirety.

### TECHNICAL FIELD

The present disclosure relates to automated valet parking (AVP: Automated Valet Parking) of a vehicle in a parking lot. The present disclosure also relates to a technique for providing a user with information related to the automated valet parking.

### BACKGROUND ART

Patent Literature 1 discloses automated valet parking in a parking lot. A vehicle that supports the automated valet parking acquires route information from a parking lot system and autonomously travels along the acquired route.

### LIST OF RELATED ART

Patent Literature 1: German Patent Application Publication No. 102012222562

### SUMMARY

Automated valet parking of a vehicle in a parking lot is considered. A user of the automated valet parking may feel a sense of anxiety if a situation of the user's vehicle in the parking lot is not known.

A first aspect relates to an information provision system applied to automated valet parking in a parking lot.

The information provision system includes one or more processors.

The one or more processors are configured to:

acquire vehicle management information including at least one of a record and a schedule of traveling and parking of each vehicle in the parking lot;

receive designation of a target time from a target user of a target vehicle;

generate, based on the vehicle management information, a bird's-eye view image showing a map of the parking lot and positions of the target vehicle and other vehicles in the parking lot at the target time with a bird's-eye view; and

provide the target user with the bird's-eye view image.

A second aspect relates to an information provision method executed by a computer and applied to automated valet parking in a parking lot.

The information providing method includes:

acquiring vehicle management information including at least one of a record and a schedule of traveling and parking of each vehicle in the parking lot;

receiving designation of a target time from a target user of a target vehicle;

generating, based on the vehicle management information, a bird's-eye view image showing a map of the parking lot and positions of the target vehicle and other vehicles in the parking lot at the target time with a bird's-eye view; and

providing the target user with the bird's-eye view image.

According to the present disclosure, the target user is provided with the bird's-eye view image showing the positions of the target vehicle and the other vehicles at the target time designated by the target user with a bird's eye view. Viewing the bird's-eye view image makes it possible for the target user to grasp the situation of the target vehicle in the parking lot. This contributes to reduction in the target user's sense of anxiety. Grasping the situation of the target vehicle in the parking lot makes it possible for the target user to achieve a sense of relief.

### BRIEF DESCRIPTION OF DRAWINGS

FIG. 1 is a conceptual diagram illustrating an overview of an automated valet parking system (AVP system);

FIG. 2 is a conceptual diagram for explaining an example of automated valet parking;

FIG. 3 is a conceptual diagram for explaining an overview of an information provision system;

FIG. 4 is a conceptual diagram for explaining an example of a bird's-eye view image;

FIG. 5 is a conceptual diagram for explaining another example of a bird's-eye view image;

FIG. 6 is a conceptual diagram for explaining an example of reservation availability determination;

FIG. 7 is a conceptual diagram for explaining an example of a change of a reservation request;

FIG. 8 is a conceptual diagram for explaining an example of another-vehicle schedule adjustment request;

FIG. 9 is a block diagram showing an example of a configuration of a vehicle;

FIG. 10 is a block diagram showing an example of a configuration of a user terminal;

FIG. 11 is a block diagram showing an example of a configuration of a back-end system;

FIG. 12 is a block diagram showing an example of a configuration of a parking lot system; and

FIG. 13 is a block diagram showing an example of a configuration of an information provision system.

### DETAILED DESCRIPTION

Embodiments of the present disclosure will be described with reference to the accompanying drawings. In the following description, automated valet parking may be referred to as "AVP".

### 1. AUTOMATED VALET PARKING SYSTEM AVP SYSTEM

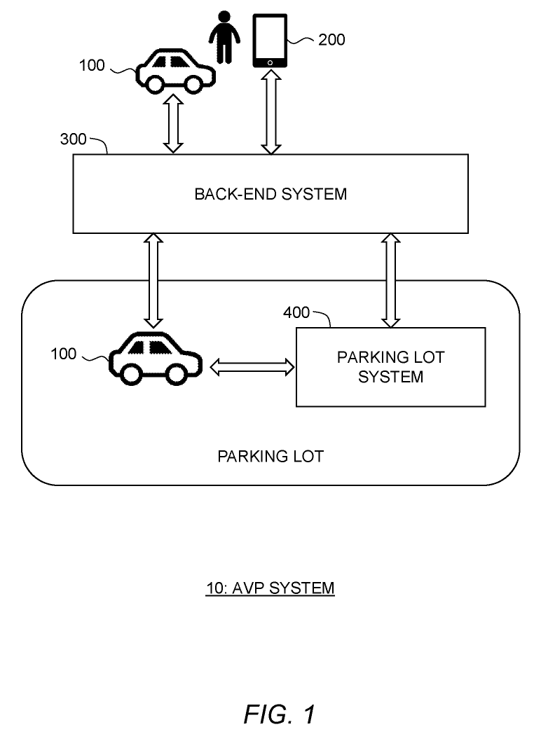

FIG. 1 is a conceptual diagram illustrating an overview of an AVP system 10 according to the present embodiment. The AVP system 10 is a system for the AVP in a parking lot. The AVP system 10 includes a vehicle 100, a user terminal 200, a back-end system 300, and a parking lot system 400.

The vehicle 100 is a target of the AVP in the parking lot. The vehicle 100 has a function of autonomously traveling at least in the parking lot.

The user terminal 200 is a terminal operated by a user of the AVP service, that is, a user of the vehicle 100. Examples of the user terminal 200 include a smartphone and a PC.

The back-end system 300 manages the AVP in one or more parking lots, users of the AVP service, and the like. The parking lot system 400, which is an infrastructure system installed in a parking lot, manages the AVP in the parking lot. The back-end system 300 and the parking lot system 400 may be collectively referred to as a "management system." The management system manages the AVP in the parking lot.

The vehicle 100 and the back-end system 300 can communicate with each other. For example, the vehicle 100 and the back-end system 300 communicate with each other using a mobile communication service. In the parking lot, the vehicle 100 and the parking lot system 400 can perform a wireless communication with each other. For example, the vehicle 100 and the parking lot system 400 perform a wireless communication with each other using a wireless LAN. Moreover, the user terminal 200 and the back-end system 300 can communicate with each other. For example, the user terminal 200 and the back-end system 300 communicate with each other using a mobile communication service. Further, the back-end system 300 and the parking lot system 400 may communicate with each other in a wired or wireless manner.

An example of a flow of a reservation of the AVP service is as follows. It is assumed that member information of the users is registered in advance in the back-end system 300. First, a user makes a reservation of the AVP. For example, the user operates the user terminal 200 to input ID information of the user, a desired parking lot, a desired date of use, a desired time of use (i.e, a scheduled entry time and a scheduled exit time), and the like. The user terminal 200 transmits reservation request information including the input information to the back-end system 300. The back-end system 300 executes reservation processing based on the reservation request information, and sends a reservation completion notification to the user terminal 200. In addition, the back-end system 300 provides reservation information to the parking lot system 400 of the reserved parking lot.

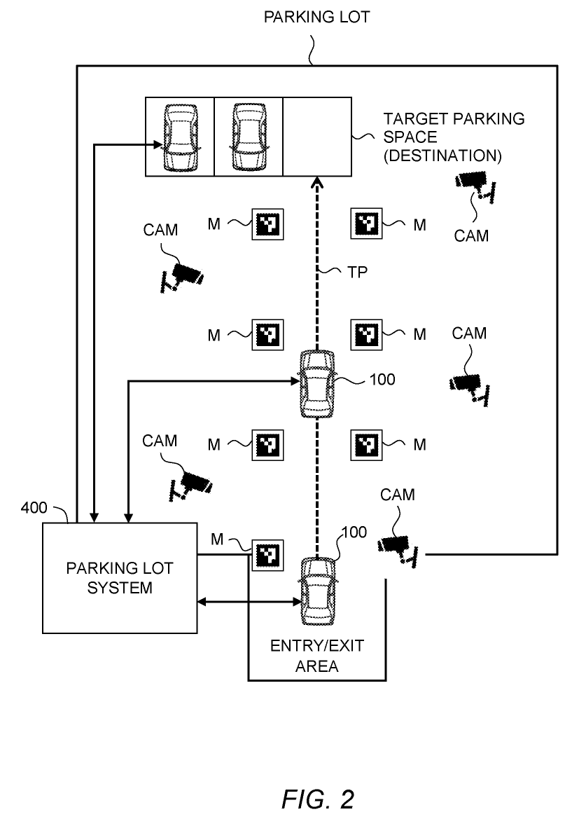

FIG. 2 is a conceptual diagram for explaining an example of the AVP in the parking lot.

The vehicle 100 recognizes a situation around the vehicle 100 by using a recognition sensor (for example, a camera) mounted on the vehicle 100. The vehicle 100 travels safely while recognizing the surrounding situation. A plurality of markers M (landmarks) may be arranged in the parking lot. The marker M is used for guiding the vehicle 100 in the parking lot. For example, the vehicle 100 acquires an image of the surroundings using the camera, and recognizes the marker M based on the image. Then, based on a result of recognition of the marker M, the vehicle 100 performs localization processing that estimates a position of the vehicle 100 in the parking lot with high accuracy. The vehicle 100 automatically travels in the parking lot based on the estimated vehicle position.

One or more infrastructure cameras CAM may be installed in the parking lot. The infrastructure camera CAM captures an image of the parking lot and acquires an image showing a situation of the parking lot. The parking lot system 400 communicates with the infrastructure camera CAM to acquire the image captured by the infrastructure camera CAM. The parking lot system 400 analyzes the image to detect the vehicle 100 shown in the image. Moreover, the parking lot system 400 estimates a position of the vehicle 100 shown in the image. Further, the parking lot system 400 manages the vehicle 100 in the parking lot based on the position of the vehicle 100. The parking lot system 400 may provide the vehicle 100 with the position information of the vehicle 100. The vehicle 100 may automatically travel in the parking lot based on the position information provided from the parking lot system 400.

An example of an entry process (check-in) is as follows. The vehicle 100 stops at an entry area. At the entry area, the user gets off the vehicle 100 and requests the entry by using the user terminal 200 or the like. The management system (i.e., at least one of the back-end system 300 and the parking lot system 400) conducts authentication of the user and the vehicle 100. Upon completion of the authentication, authority to operate the vehicle 100 is transferred from the user to the management system. The management system communicates with the vehicle 100 and activates the vehicle 100. Moreover, the parking lot system 400 allocates an available parking space to the vehicle 100. The allocated available parking space is a target parking space, that is, a destination for the vehicle 100 at the time of the entry. Further, the parking lot system 400 sets a travel path TP (a target trajectory) from the entry area to the target parking space in the parking lot. The parking lot system 400 sends an entry instruction to the vehicle 100. The entry instruction includes information on the target parking space and the travel path TP. In response to the entry instruction, the vehicle 100 automatically travels to the target parking space along the travel path TP. That is, the vehicle 100 automatically travels so as to follow the travel path TP based on the vehicle position. Then, the vehicle 100 is automatically parked in the target parking space. Upon completion of the parking, the management system instructs the vehicle 100 to stop the operation.

An example of an exit process (check-out) is as follows. The user requests the exit by using the user terminal 200 or the like. The management system communicates with the vehicle 100 and activates the vehicle 100. At the time of exit, a designated exit area is a destination for the vehicle 100. The parking lot system 400 sets a travel path TP (a target trajectory) from the parking space to the exit area in the parking lot. The parking lot system 400 sends an exit instruction to the vehicle 100. The exit instruction includes information on the designated exit area and the travel path TP. In response to the exit instruction, the vehicle 100 automatically travels to the exit area along the travel path TP. That is, the vehicle 100 automatically travels so as to follow the travel path TP based on the vehicle position. Then, the vehicle 100 automatically stops the vehicle 100 in the exit area. The authority to operate the vehicle 100 is transferred from the management system to the user. The user gets on the vehicle 100. The vehicle 100 starts moving to a next destination.

An additional service facility for providing an additional service (supplementary service) such as charging, car washing, maintenance, and the like may be installed in the parking lot. Using such the additional service makes it possible for the user to effectively utilize a period of parking from the entry to the exit. More specifically, a user who desires the additional service applies for the additional service by the use of the user terminal 200. The management system manages a usage status and a reservation status of the additional service facility, and allocates a period of time in which the additional service facility is available during the period of parking to the vehicle 100 of the user. The parking lot system 400 sets a travel path TP (outbound path) from the parking space allocated to the vehicle 100 (that is, the parking space in which the vehicle 100 is parked) to the additional service facility. Moreover, the parking lot system 400 sets a travel path TP (return path) from the additional service facility to the allocated parking space. Then, the parking lot system 400 transmits a movement instruction including the travel path TP (i.e., the outbound path) to the vehicle 100 so as to be in time for the service provision period of time allocated to the vehicle 100. In response to the movement instruction, the vehicle 100 automatically travels from the allocated parking space to the additional service facility along the travel path TP. The vehicle 100 stops at the additional service facility and receives the additional service. When the additional service is completed, the parking lot system 400 transmits a movement instruction including the travel path TP (i.e., the return path) to the vehicle 100. In response to the movement instruction, the vehicle 100 automatically travels from the additional service facility to the allocated parking space along the travel path TP.

### 2. INFORMATION PROVISION SYSTEM

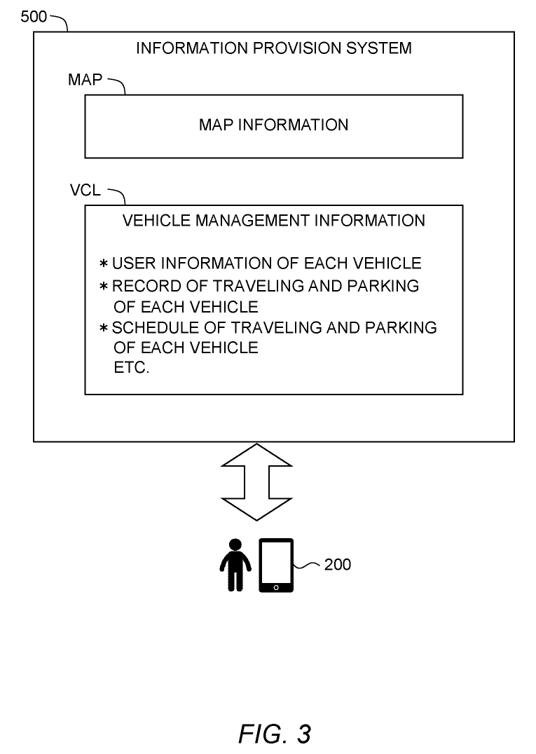

FIG. 3 is a conceptual diagram for explaining an overview of an information provision system 500 according to the present embodiment. The information provision system 500 is configured to provide the user of the AVP with a variety of information regarding the AVP. In addition, the information provision system 500 may be configured to receive a variety of requests regarding the AVP from the user of the AVP. The information provision system 500 may be configured to provide the user with information regarding the AVP in response to the request from the user. It can also be said that the information provision system 500 provides the user of the AVP with a user interface.

The information provision system 500 is configured to be able to share information with the user terminal 200 of the user of the AVP. The information provision system 500 is able to receive a variety of requests from the user via the user terminal 200 and provide the user with a variety of information via the user terminal 200. For example, the information provision system 500 includes the back-end system 300 that is able to communicate with the user terminal 200. The back-end system 300 is able to receive a variety of requests from the user and provide the user with a variety of information by communicating with the user terminal 200. The information provision system 500 may include the parking lot system 400. The parking lot system 400 is able to communicate with the user terminal 200 via the back-end system 300. As still another example, the information provision system 500 may be a separate system that is separate from the back-end system 300 and the parking lot system 400, but is capable of sharing information with the back-end system 300 and the parking lot system 400. As still another example, the information provision system 500 may include the user terminal 200 itself. In either case, the information provision system 500 is able to receive a variety of requests from the user and provide the user with a variety of information.

The information provision system 500 acquires map information MAP indicating a map of the parking lot. The map information MAP indicates a configuration (arrangement) of roads in the parking lot. In addition, the map information MAP may indicate a configuration (arrangement) of stationary obstacles (for example, walls and pillars) in the parking lot. The map information MAP is acquired from, for example, the parking lot system 400 installed in the parking lot.

Moreover, the information provision system 500 acquires vehicle management information VCL. The vehicle management information VCL is information for managing each vehicle 100 being a target of the AVP. The vehicle 100 being the target of the AVP includes a vehicle 100 that is currently present in the parking lot. The vehicle 100 being the target of the AVP may include a vehicle 100 that has a reservation of the AVP, that is, a vehicle 100 scheduled to use the parking lot in the future. The vehicle management information VCL is acquired from the back-end system 300 or the parking lot system 400.

The vehicle management information VCL includes user information (for example, a user ID) of each vehicle 100. This makes it possible to grasp a correspondence relationship between the user and the vehicle 100.

In addition, the vehicle management information VCL includes at least one of record information and schedule information.

The record information indicates a record of traveling and parking of each vehicle 100 in the parking lot. For example, the record information includes a record of position information for each time of each vehicle 100 in the parking lot. The position information for each time of each vehicle 100 is acquired from the parking lot system 400 or each vehicle 100. The record information may include information on the parking space and the travel path TP of each vehicle 100. The record information may include the entry time, the exit time, the period of use of the additional service facility, and the like of each vehicle 100.

The schedule information includes a scheduled entry time, a scheduled exit time, a scheduled period of use of the additional service facility, and the like of each vehicle 100. The scheduled entry time, the scheduled exit time, the scheduled period of use of the additional service facility, and the like of each vehicle 100 are acquired from the reservation information managed by the back-end system 300 or the parking lot system 400. As to the vehicle 100 that has a reservation of the AVP, a parking space may be temporarily allocated based on the usage status of the parking lot at the scheduled entry time. When the parking space is temporarily allocated, a travel path TP is also temporarily determined. The schedule information may include information on the scheduled parking space and the scheduled travel path of each vehicle 100.

The information provision system 500 performs an information provision process based on the map information MAP and the vehicle management information VCL. Hereinafter, a variety of examples of the information provision process will be described. In the following description, a user who receives the information is referred to as a "target user", and a vehicle 100 of the target user is referred to as a "target vehicle 100T". It can be said that the target vehicle 100T is the vehicle 100 of the target user. Vehicles other than the target vehicle 100T are referred to as "other vehicles 100X".

### 2-1. Provision Presentation of Bird's-Eye View Image

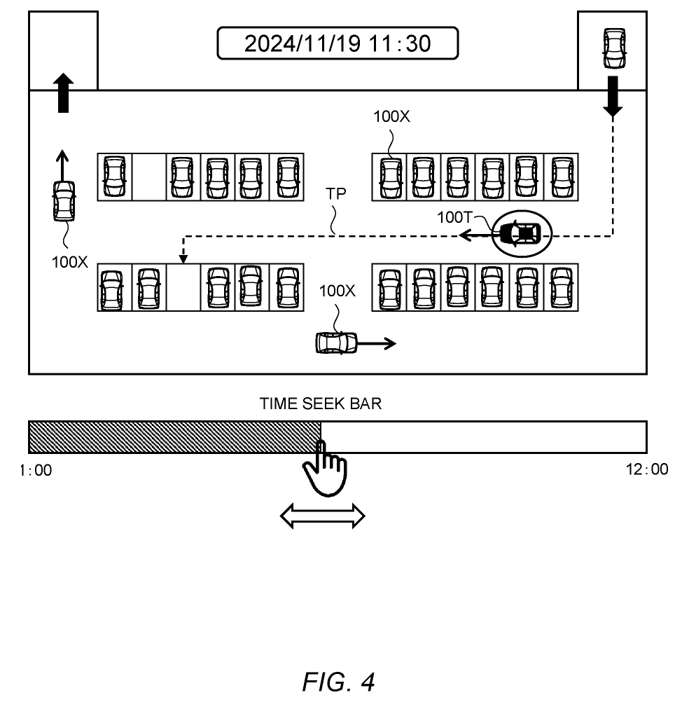

FIG. 4 is a conceptual diagram for explaining an example of an bird's-eye view image IMG of the parking lot. The bird's-eye view image IMG shows the position of each vehicle 100 in the parking lot together with the map of the parking lot with a bird's eye view. The vehicles 100 in the parking lot include the target vehicle 100T of the target user and other vehicles 100X other than the target vehicle 100T. The information provision system 500 may provide (present) such the bird's-eye view image IMG to the target user. The information provision system 500 may receive an bird's-eye view image request from the target user and then provide (present) the bird's-eye view image IMG to the target user in response to the bird's-eye view image request.

More specifically, the target user designates a desired timing or a desired period of time as a "target time". The target user is able to designate the target time by operating the user terminal 200. The information provision system 500 receives the designation of the target time from the target user. That is, the information provision system 500 acquires information on the target time designated by the target user.

Subsequently, the information provision system 500 generates the bird's-eye view image IMG at the target time based on the map information MAP of the parking lot, the vehicle management information VCL, and the target time. In the present example, the vehicle management information VCL includes the record information indicating the record of traveling and parking of each vehicle 100 in the parking lot. Based on the record information, the information provision system 500 is able to acquire the position of each vehicle 100 at the target time. Then, the information provision system 500 generates the bird's-eye view image IMG at the target time by combining the map information MAP and the position of each vehicle 100 at the target time. The bird's-eye view image IMG thus generated shows the map of the parking lot and the positions of the target vehicle 100T and the other vehicles 100X in the parking lot at the target time with a bird's-eye view. The bird's-eye view image IMG may be generated in real time.

Then, the information provision system 500 provides (presents) the generated bird's-eye view image IMG to the target user. More specifically, the information provision system 500 instructs the user terminal 200 operated by the target user to display the bird's-eye view image IMG on its screen. The user terminal 200 displays the bird's-eye view image IMG on the screen. Viewing the bird's-eye view image IMG makes it possible for the target user to grasp the situation of the target vehicle 100T in the parking lot. This contributes to reduction in the target user's sense of anxiety. Grasping the situation of the target vehicle 100T in the parking lot makes it possible for the target user to achieve a sense of relief.

As illustrated in FIG. 4, the bird's-eye view image IMG may show the travel path TP and the allocated parking space of the target vehicle 100T.

As illustrated in FIG. 4, the information provision system 500 may generate the bird's-eye view image IMG such that the target vehicle 100T is distinguishable from the other vehicles 100X. For example, the information provision system 500 sets a color of the target vehicle 100T to be different from a color of the other vehicles 100X. As another example, the information provision system 500 may circle the target vehicle 100T. As still another example, the information provision system 500 may highlight the target vehicle 100T.

As illustrated in FIG. 4, the information provision system 500 may display a time seek bar together with the bird's-eye view image IMG on the screen (for example, a touch panel) of the user terminal 200 operated by the target user. The target user is able to designate the target time (target timing) by operating the time seek bar on the screen of the user terminal 200. The information provision system 500 receives, as the target time (target timing), a time designated by the operation of the time seek bar on the screen of the user terminal 200. By continuously changing the target time using the time seek bar, it is also possible to see how each vehicle 100 in the parking lot moves.

As described above, according to the present embodiment, the target user is provided with the bird's-eye view image IMG showing the positions of the target vehicle 100T and the other vehicles 100X at the target time designated by the target user with a bird's-eye view. Viewing the bird's-eye view image IMG makes it possible for the target user to grasp the situation of the target vehicle 100T in the parking lot. This contributes to reduction in the target user's sense of anxiety. Grasping the situation of the target vehicle 100T in the parking lot makes it possible for the target user to achieve a sense of relief.

The target user can see the situation of the target vehicle 100T during the entry process. The target user can also see the situation of the target vehicle 100T after the entry process. The parking position of the target vehicle 100T may be changed from the original one due to a parking position change (reallocation) after the entry process. It is convenient to know the latest parking position when the user wants to go to pick up a thing left behind.

### 2-2. Provision Presentation of Bird's-Eye View Image in Reservation Stage

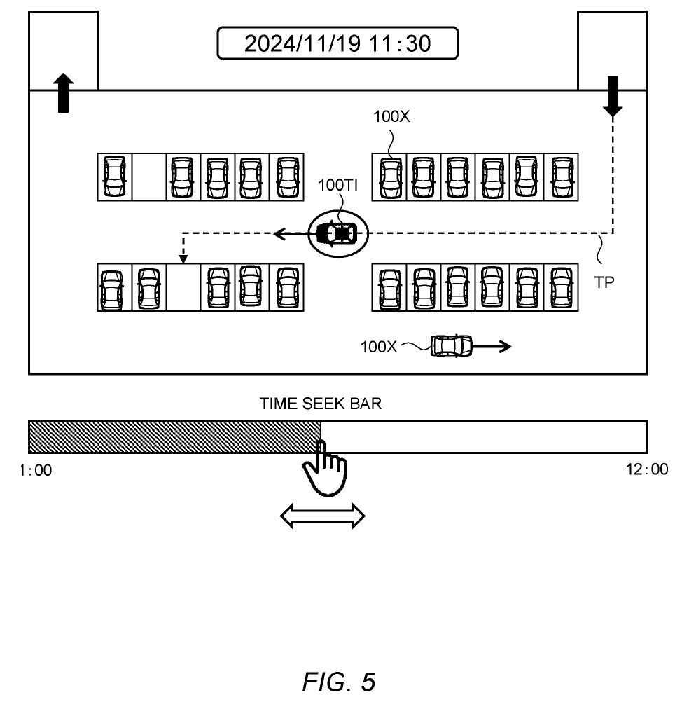

In the stage of the reservation of the AVP for the target vehicle 100T, the information provision system 500 may provide the target user with a future bird's-eye view image IMG. In this case, the future bird's-eye view image IMG is generated based on the schedule information in the vehicle management information VCL. FIG. 5 shows an example of the future bird's-eye view image IMG.

First, the information provision system 500 receives a reservation request for the AVP of the target vehicle 100T from the target user. More specifically, the target user operates the user terminal 200 to input ID information of the target user, a desired parking lot, a desired date of use, a desired time of use (i.e, a scheduled entry time and a scheduled exit time), a desire to use the additional service, and the like. The user terminal 200 transmits the reservation request including the input information to the back-end system 300. The information provision system 500 acquires the reservation request and reflects the reservation request in the schedule information. That is, the information provision system 500 updates the schedule information by adding the reservation request from the target user to the schedule information.

It is assumed that the target vehicle 100T travels and is parked in accordance with the reservation request from the target user. The target vehicle 100T that assumptively travels and is parked in accordance with the reservation request is hereinafter referred to as an "imaginary target vehicle 100TI".

The schedule information includes the schedule of traveling and parking of the imaginary target vehicle 100TI in the parking lot. The schedule information further includes the schedule of traveling and parking of the other vehicles 100X in the parking lot. Based on the schedule information, the information provision system 500 simulates a future situation of the parking lot to estimate positions of the imaginary target vehicle 100TI and the other vehicles 100X in the parking lot at the target time.

For example, the information provision system 500 grasps, based on the schedule information, a future usage status of the parking lot and allocates an available parking space to the imaginary target vehicle 100TI at the time of entry. Further, the information provision system 500 sets a travel path TP from the entry area to the allocated parking space. A rule of a vehicle speed in the parking lot is predetermined. The information provision system 500 is able to estimate the position of the imaginary target vehicle 100TI for each time during the entry process, based on the scheduled entry time, the travel path TP, and the rule of the vehicle speed. The imaginary target vehicle 100TI is parked in the allocated parking space until the scheduled exit time or start of the use of the additional service. The position of the imaginary target vehicle 100TI during the exist process or during the period of use of the additional service can also be estimated in the same manner as in the case of the entry process. The positions of the other vehicles 100X can also be estimated in the same manner as in the case of the imaginary target vehicle 100TI.

Then, the information provision system 500 generates the bird's-eye view image IMG at the target time by combining the map information MAP and the estimated position of each vehicle 100 at the target time. The bird's-eye view image IMG thus generated shows the map of the parking lot and the estimated positions of the imaginary target vehicle 100TI and the other vehicles 100X in the parking lot at the target time with a bird's-eye view. Then, the information provision system 500 provides (presents) the generated bird's-eye view image IMG to the target user.

Others are the same as in the case of FIG. 4. The bird's-eye view image IMG may show the travel path TP and the allocated parking space of the imaginary target vehicle 100TI. The bird's-eye view image IMG may be generated such that the imaginary target vehicle 100TI is distinguishable from the other vehicles 100X. The time seek bar may be displayed on the screen (for example, a touch panel) of the user terminal 200 operated by the target user together with the bird's-eye view image IMG.

### 2-3. Reservation Availability Determination

The information provision system 500 may determine whether the reservation request from the target user is acceptable or not. This process is hereinafter referred to as "reservation availability determination".

As described above, the information provision system 500 is able to estimate the positions of the imaginary target vehicle 100TI and the other vehicles 100X in the parking lot based on the schedule information. Therefore, the information provision system 500 is able to determine whether there is a possibility of interference between the imaginary target vehicle 100TI and any of the other vehicles 100X. Here, "there is a possibility of interference" means that, for example, a distances between the imaginary target vehicle 100TI and any of the other vehicles 100X becomes less than a threshold. As another example, "there is a possibility of interference" may mean that a TTC (Time to Collision) between the imaginary target vehicle 100TI and any of the other vehicles 100X becomes less than a predetermined value.

In an example illustrated in FIG. 5, it is determined that there is no possibility of interference between the imaginary target vehicle TI and any of the other vehicles 100X. In this case, the information provision system 500 accepts (grants) the reservation request from the target user. Then, the information provision system 500 provides the target user with a reservation acceptance notification indicating that the reservation request has been accepted. For example, the user terminal 200 of the target user displays the reservation acceptance notification on the screen.

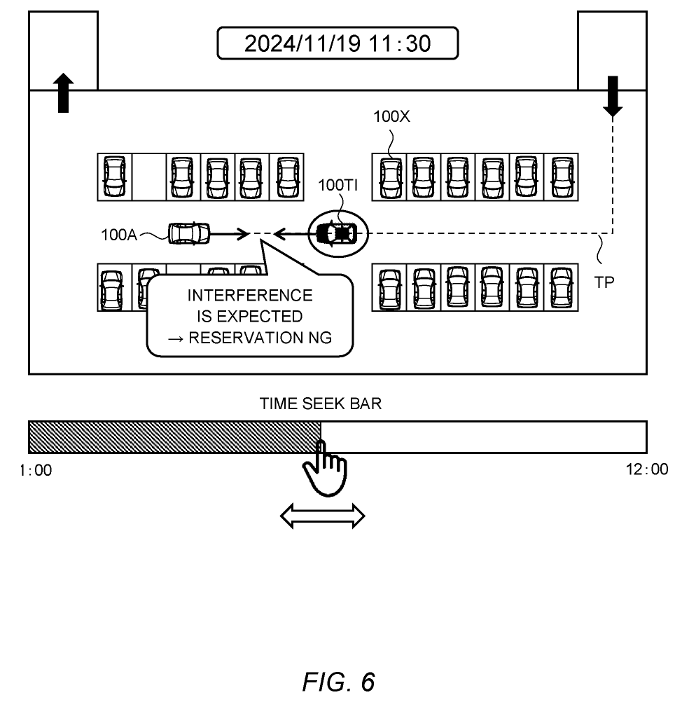

On the other hand, in an example shown in FIG. 6, it is determined that there is a possibility of interference between the imaginary target vehicle 100TI and a first vehicle 100A among the other vehicles 100X. In this case, the information provision system 500 rejects the reservation request from the target user. Then, the information provision system 500 provides the target user with a reservation unavailable notification indicating that the reservation request is not acceptable. For example, the user terminal 200 of the target user displays the reservation unavailable notification on the screen.

### 2-4. Change of Reservation Request

The target user who has received the reservation unavailable notification may consider changing the content of the reservation request. At this time, viewing the bird's-eye view image IMG including the imaginary target vehicle 100TI and the first vehicle 100A makes it possible for the target user to visually grasp why and how the interference between the imaginary target vehicle 100TI and the first vehicle 100A occurs. Visually grasping why and how the interference between the imaginary target vehicle 100TI and the first vehicle 100A occurs facilitates considering how to change the reservation request in order to avoid the interference. Also in this sense, it is useful to provide the target user with the bird's-eye view image IMG.

The target user operates the user terminal 200 to change the content of the reservation request. The information provision system 500 receives the change of the reservation request from the target user. Then, the information provision system 500 performs the above-described reservation availability determination with respect to the new reservation request.

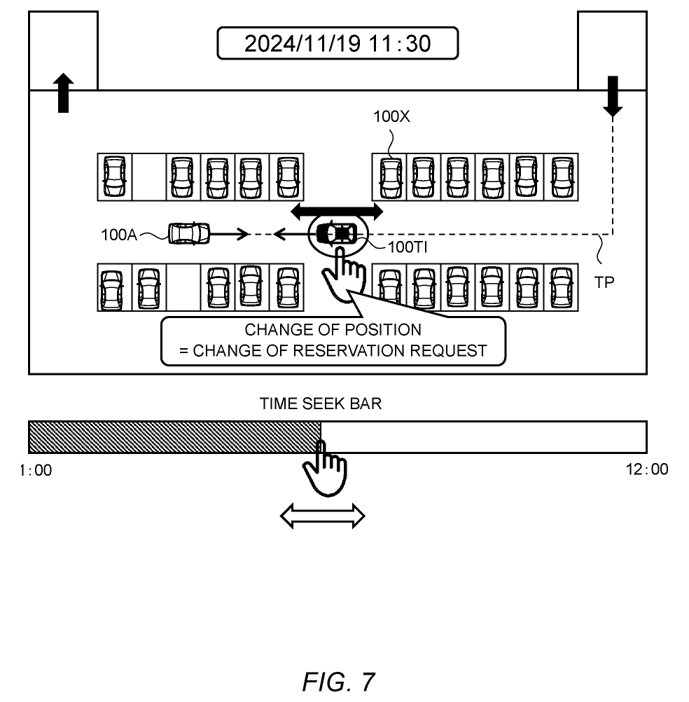

FIG. 7 is a conceptual diagram for explaining an example of the change of the reservation request. The information provision system 500 displays the bird's-eye view image IMG on the screen of the user terminal 200 operated by the target user. A display position of the imaginary target vehicle 100TI on the screen of the user terminals 200 is changeable by an operation performed by the target user. For example, the screen is a touch panel. The target user can change the display position of the imaginary target vehicle 100TI by touching and dragging the imaginary target vehicle 100TI displayed on the touch panel. As another example, the target user may change the display position of the imaginary target vehicle 100TI by clicking and dragging the imaginary target vehicle 100TI on the screen using a mouse. Changing the display position of the imaginary target vehicle 100TI on the screen is equivalent to changing the scheduled entry time or the scheduled exit time. Therefore, the information provision system 500 receives the change of the display position of the imaginary target vehicle 100TI on the screen as the change of the reservation request.

As described above, in the example shown in FIG. 7, it is possible to visually change the reservation request while viewing the bird's-eye view image IMG. This improves convenience.

### 2-5. Another-Vehicle Schedule Adjustment Request

The vehicle 100 may move in the parking lot due to a parking position change (reallocation). As another example, the vehicle 100 may move in the parking lot in order to use the additional service (for example, charging, car washing, maintenance) during the parking period. A schedule of such the movement is not so strict and has a room for adjustment.

The target user who has received the reservation unavailable notification may request adjustment of the schedule of the first vehicle 100A. At this time, viewing the bird's-eye view image IMG including the imaginary target vehicle 100TI and the first vehicle 100A makes it possible for the target user to visually grasp why and how the interference between the imaginary target vehicle 100TI and the first vehicle 100A occurs. Visually grasping why and how the interference between the imaginary target vehicle 100TI and the first vehicle 100A occurs facilitates considering how to change the schedule of the first vehicle 100A in order to avoid the interference. Also in this sense, it is useful to provide the target user with the bird's-eye view image IMG.

The target user operates the user device 200 to request adjustment of the schedule of the first vehicle 100A. This request is hereinafter referred to as "another-vehicle schedule adjustment request".

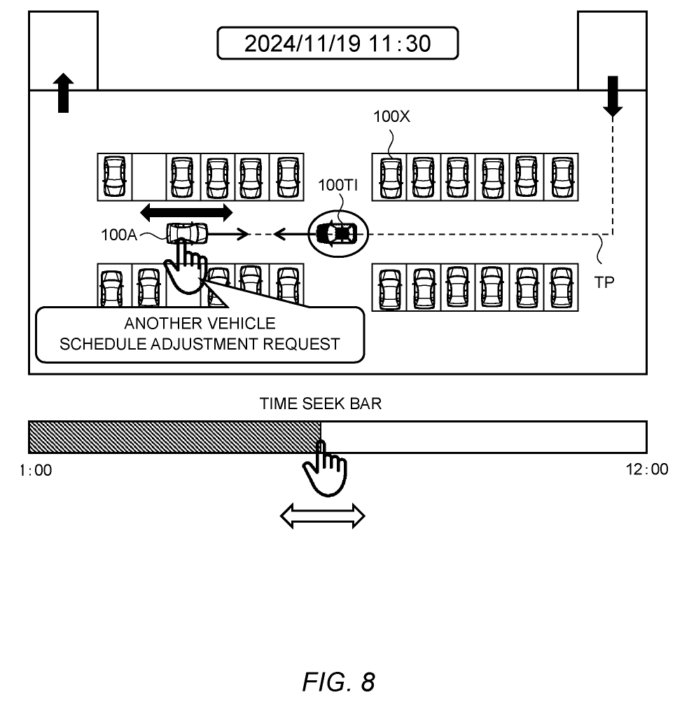

FIG. 8 is a conceptual diagram for explaining an example of another-vehicle schedule adjustment request. The information provision system 500 displays the bird's-eye view image IMG on the screen of the user terminal 200 operated by the target user. A display position of the first vehicle 100A on the screen of the user device 200 is changeable by an operation performed by the target user. For example, the screen is a touch panel. The target user can change the display position of the first vehicle 100A by touching and dragging the first vehicle 100A displayed on the touch panel. As another example, the target user may change the display position of the first vehicle 100A by clicking and dragging the first vehicle 100A on the screen using a mouse. Changing the display position of the first vehicle 100A on the screen is equivalent to changing the schedule of movement of the first vehicle 100A. Therefore, the information provision system 500 receives the change of the display position of the first vehicle 100A on the screen as the another vehicle schedule adjustment request. In this manner, in the example shown in FIG. 8, it is possible to visually request the schedule adjustment while viewing the bird's-eye view image IMG. This improves convenience.

The information provision system 500 receives another-vehicle schedule adjustment request from the target user. The information provision system 500 determines whether the received another-vehicle schedule adjustment request is acceptable or not based on the schedule information. In other words, the information provision system 500 determines, based on the schedule information, whether or not the schedule of the first vehicle 100A is adjustable so as not to cause interference between the imaginary target vehicle 100TI and the first vehicle 100A.

When the schedule of the first vehicle 100A is adjustable, the information provision system 500 accepts (grants) the received another-vehicle schedule adjustment request. The information provision system 500 updates the schedule of the first vehicle 100A to update the schedule information. In addition, the information provision system 500 receives the reservation request from the target user. The information provision system 500 provides the target user with a reservation acceptance notification indicating that both the another-vehicle schedule adjustment request and the reservation request have been accepted. For example, the user terminal 200 of the target user displays the reservation acceptance notification on the screen.

On the other hand, when the schedule of the first vehicle 100A is not adjustable, the information provision system 500 rejects the received another-vehicle schedule adjustment request. Then, the information provision system 500 provides the target user with a rejection notification indicating that the another-vehicle schedule adjustment is not possible. For example, the user terminal 200 of the target user displays the rejection notification on the screen.

### 3. CONFIGURATION EXAMPLE OF VEHICLE

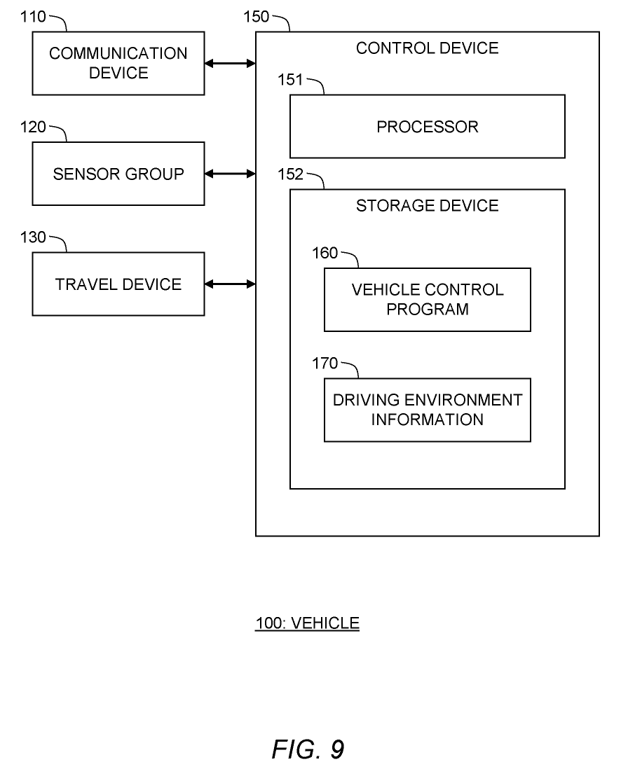

FIG. 9 is a block diagram showing a configuration example of the vehicle 100 according to the present embodiment. The vehicle 100 includes a communication device 110, a sensor group 120, a travel device 130, and a control device 150.

The communication device 110 communicates with the outside via a communication network. For example, the communication device 110 communicates with the back-end system 300. In addition, the communication device 110 communicates with the parking lot system 400 via a wireless LAN.

The sensor group 120 includes a recognition sensor, a vehicle state sensor, and the like. The recognition sensor is used for recognizing (detecting) a situation around the vehicle 100. Examples of the recognition sensor include a camera, a laser imaging detection and ranging (LIDAR), a radar, and the like. The vehicle state sensor includes a speed sensor, an acceleration sensor, a yaw rate sensor, a steering angle sensor, and the like.

The travel device 130 includes a steering device, a driving device, and a braking device. The steering device turns wheels. For example, the steering device includes an electric power steering (EPS) device. The driving device is a power source that generates a driving force. Examples of the driving device include an engine, an electric motor, an in-wheel motor, and the like. The braking device generates a braking force.

The control device 150 is a computer that controls the vehicle 100. The control device 150 includes one or more processors 151 (hereinafter, simply referred to as a processor 151) and one or more storage devices 152 (hereinafter, simply referred to as a storage device 152). The processor 151 executes a variety of processing. Examples of the processor 151 include a general-purpose processor, a special-purpose processor, a central processing unit (CPU), a graphics processing unit (GPU), an application specific integrated circuit (ASIC), a field-programmable gate array (FPGA), an integrated circuit, and / or a combination thereof. The processor 151 may also be referred to as processing circuitry. The storage device 152 stores a variety of information. Examples of the storage device 152 include a volatile memory, a nonvolatile memory, a hard disk drive (HDD), a solid state drive (SSD), and the like.

A vehicle control program 160 is a computer program for controlling the vehicle 100. The functions of the control device 150 may be realized by a cooperation between the processor 151 executing the vehicle control program 160 and the storage device 152. The vehicle control program 160 is stored in the storage device 152. Alternatively, the vehicle control program 160 may be recorded on a non-transitory computer-readable recording medium.

The control device 150 executes vehicle travel control for controlling travel of the vehicle 100. The vehicle travel control includes steering control, acceleration control, and deceleration control. The control device 150 executes the vehicle travel control by controlling the travel device 130 (i.e., the steering device, the driving device, and the braking device).

The control device 150 communicates with the back-end system 300 and the parking lot system 400 via the communication device 110.

The control device 150 acquires driving environment information 170 indicating a driving environment for the vehicle 100. The driving environment information 170 is stored in the storage device 152. For example, the driving environment information 170 includes surrounding situation information, vehicle state information, map information, position information, and the like.

The surrounding situation information indicates the result of recognition by the recognition sensor. The surrounding situation information may include object information regarding an object recognized by the recognition sensor. Examples of the object around the vehicle 100 include an obstacle, a white line, a marker M, and the like. Examples of the obstacle include a wall, a pillar, another vehicle, and the like. The object information indicates a relative position and a relative speed of the object with respect to the vehicle 100.

The vehicle state information indicates the vehicle state detected by the vehicle state sensor. Examples of the vehicle state include a speed, an acceleration, a yaw rate, a steering angle, and the like.

The map information is map information of the parking lot in which the vehicle 100 travels. The map information indicates an arrangement of roads in the parking lot. In addition, the map information indicates an arrangement of stationary obstacles (for example, walls and pillars) in the parking lot. The map information further indicates an arrangement of the markers M in the parking lot. For example, the map information is provided from the parking lot system 400 that manages the parking lot. The control device 150 acquires the map information from the parking lot system 400 via the communication device 110.

The position information indicates a current position of the vehicle 100 in the parking lot. For example, the control device 150 acquires the position information with high accuracy by performing localization processing (localization). More specifically, the control device 150 calculates a rough position of the vehicle 100 in the parking lot based on the vehicle state information (specifically, the steering angle and the speed). Moreover, the control device 150 recognizes the marker M around the vehicle 100 by using the recognition sensor. In addition, the control device 150 acquires the arrangement information of the markers M around the vehicle 100 from the map information. The control device 150 corrects the position of the vehicle 100 by matching the recognition result of the marker M with the arrangement of the markers M. Accordingly, the position information with high accuracy is obtained.

Alternatively, the position information of the vehicle 100 may be estimated by the parking lot system 400 based on the image captured by the infrastructure camera CAM. In this case, the control device 150 may acquire the position information from the parking lot system 400.

Further, the control device 150 acquires information on the travel path TP in the parking lot. For example, the travel path TP is determined by the parking lot system 400, and the control device 150 acquires information on the travel path TP from the parking lot system 400 via the communication device 110. As another example, the control device 150 may determine the travel path TP based on the map information and the position information. Then, the control device 150 executes the vehicle travel control based on the position information such that the vehicle 100 travels along the travel path TP.

### 4. CONFIGURATION EXAMPLE OF USER TERMINAL

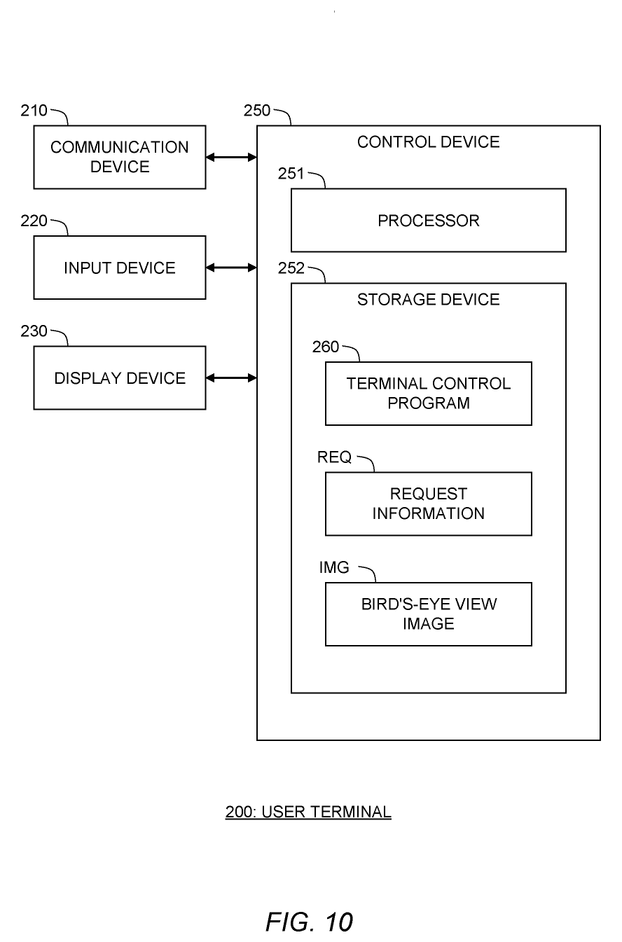

FIG. 10 is a block diagram showing a configuration example of the user terminal 200 according to the present embodiment. The user terminal 200 includes a communication device 210, an input device 220, a display device 230, and a control device 250.

The communication device 210 communicates with the outside via a communication network. For example, the communication device 210 communicates with the back-end system 300. In addition, the communication device 210 communicates with the information provision system 500.

Examples of the input device 220 include a touch panel, a button, a microphone, and the like.

Examples of the display device 230 include a touch panel, a display, and the like. The display device 230 and the input device 220 may be the same touch panel.

The control device 250 is a computer that controls the user terminal 200. The control device 250 includes one or more processors 251 (hereinafter, simply referred to as a processor 251) and one or more storage devices 252 (hereinafter, simply referred to as a storage device 252). The processor 251 executes a variety of processing. Examples of the processor 251 include a general purpose processor, a special purpose processor, a CPU, a GPU, an ASIC, an FPGA, an integrated circuit, and / or combinations thereof. The processor 251 may also be referred to as processing circuitry. The storage device 252 stores a variety of information. Examples of the storage device 252 include a volatile memory, a nonvolatile memory, an HDD, an SSD, and the like.

A terminal control program 260 is a computer program for controlling the user terminal 200. The terminal control program 260 includes an AVP application. The functions of the control device 250 may be realized by a cooperation between the processor 251 executing the terminal control program 260 and the storage device 252. The terminal control program 260 is stored in the storage device 252. Alternatively, the terminal control program 260 may be recorded on a non-transitory computer-readable recording medium.

The control device 250 communicates with the back-end system 300 and the information provision system 500 via the communication device 210.

The user can designate the target time of the bird's-eye view image IMG by the use of the input device 220. The control device 250 transmits information on the target time designated by the user to the information provision system 500.

Moreover, the user can input a request regarding the AVP by the use of the input device 220. For example, the user requests a reservation for use of the AVP (reservation request). As another example, the user may request provision of the bird's-eye view image IMG (bird's-eye view image provision request). As yet another example, the user may request a change of the content of the reservation request (reservation change request). As still another example, the user may request adjustment of the schedule of another vehicle 100X (another vehicle schedule adjustment request). Request information REQ indicates the content of the request input by the user. The control device 250 transmits the request information REQ to the information provision system 500 via the communication device 210.

The control device 250 acquires the bird's-eye view image IMG. For example, the bird's-eye view image IMG is generated by the back-end system 300, and the control device 250 receives the bird's-eye view image IMG from the back-end system 300. As another example, the control device 250 may receive the map information MAP and the vehicle management information VCL from the back-end system 300, and generate the bird's-eye view image IMG based on the map information MAP and the vehicle management information VCL. In the latter case, the information provision system 500 may be said to be a concept including the user terminal 200.

The control device 250 stores the acquired bird's-eye view image IMG in the storage device 252. Moreover, the control device 250 displays the bird's-eye view image IMG on the display device 230.

### 5. CONFIGURATION EXAMPLE OF BACK-END SYSTEM

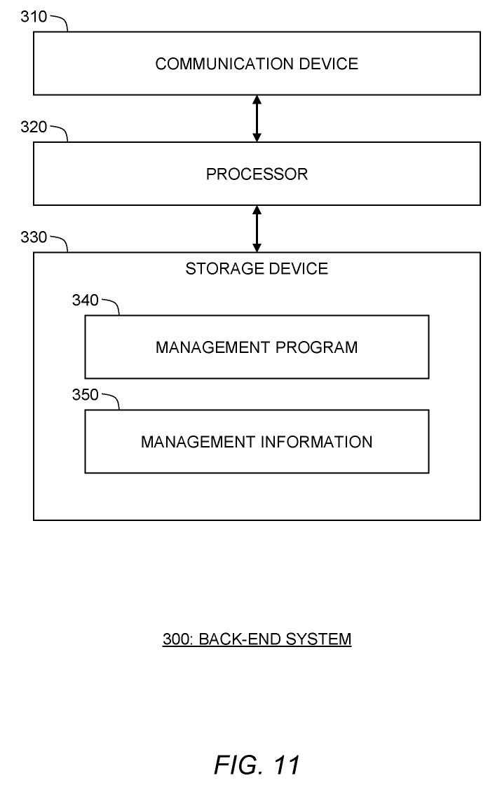

FIG. 11 is a block diagram showing a configuration example of the back-end system 300 according to the present embodiment. The back-end system 300 includes a communication device 310, one or more processors 320 (hereinafter simply referred to as a processor 320), and one or more storage devices 330 (hereinafter simply referred to as a storage device 330).

The communication device 310 communicates with each vehicle 100. In addition, the communication device 310 communicates with the user terminal 200 of each user. Further, the communication device 310 communicates with the parking lot system 400 of each parking lot.

The processor 320 executes a variety of processing. Examples of the processor 320 include a general purpose processor, a special purpose processor, a CPU, a GPU, an ASIC, an FPGA, an integrated circuit, and / or combinations thereof. The processor 320 may also be referred to as processing circuitry. The storage device 330 stores a variety of information. Examples of the storage device 330 include a volatile memory, a nonvolatile memory, an HDD, an SSD, and the like.

A management program 340 is a computer program for managing the AVP in the parking lot. The functions of the back-end system 300 may be realized by a cooperation between the processor 320 executing the management program 340 and the storage device 330. The management program 340 is stored in the storage device 330. The management program 340 may be recorded on a non-transitory computer-readable recording medium.

The processor 320 communicates with the vehicle 100, the user terminal 200, and the parking lot system 400 via the communication device 310.

The storage device 330 stores management information 350. The management information 350 may include the user information and the reservation information regarding each user. The management information 350 may include facility information and reservation status information regarding each parking lot.

The management information 350 may include the map information MAP of the parking lot. The management information 350 may include the vehicle management information VCL. The processor 320 may provide the function of the information provision system 500. More specifically, the processor 320 receives the request information REQ from the user terminal 200. In addition, the processor 320 receives information on the target time designated by the user from the user terminal 200. Moreover, the processor 320 generates the bird's-eye view image IMG based on the map information MAP and the vehicle management information VCL. Further, the processor 320 transmits the generated bird's-eye view image IMG to the user terminal 200.

### 6. CONFIGURATION EXAMPLE OF PARKING LOT SYSTEM

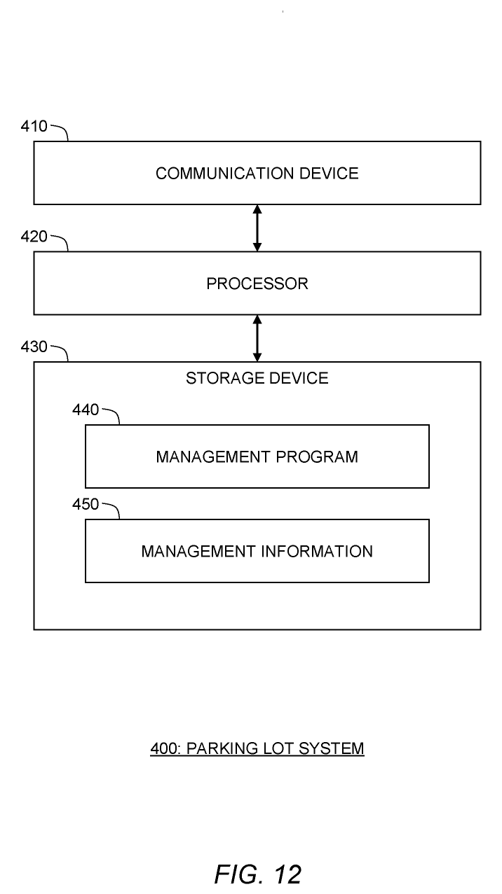

FIG. 12 is a block diagram showing a configuration example of the parking lot system 400 according to the present embodiment. The parking lot system 400 includes a communication device 410, one or more processors 420 (hereinafter simply referred to as a processor 420), and one or more storage devices 430 (hereinafter simply referred to as a storage device 430).

The communication device 410 communicates with each vehicle 100. In addition, the communication device 410 communicates with the back-end system 300. Further, the communication device 410 may communicate with the infrastructure camera CAM installed in the parking lot.

The processor 420 executes a variety of processing. Examples of the processor 420 include a general purpose processor, a special purpose processor, a CPU, a GPU, an ASIC, an FPGA, an integrated circuit, and / or combinations thereof. The processor 420 may also be referred to as processing circuitry. The storage device 430 stores a variety of information. Examples of the storage device 430 include a volatile memory, a nonvolatile memory, an HDD, an SSD, and the like.

A management program 440 is a computer program for managing the parking lot. The functions of the parking lot system 400 may be realized by a cooperation between the processor 420 executing the management program 440 and the storage device 430. The management program 440 is stored in the storage device 430. The management program 440 may be recorded on a non-transitory computer-readable recording medium.

The processor 420 communicates with the vehicle 100 and the back-end system 300 via the communication device 410. The processor 420 may also communicate with the user terminal 200 via the communication device 410 and the back-end system 300.

The storage device 430 stores management information 450 for managing the parking lot. The management information 450 includes the map information MAP of the parking lot. The processor 420 may provide the map information MAP to the vehicle 100 via the communication device 410. Moreover, the management information 450 indicates a usage status (vacancy status) of the parking spaces in the parking lot. The processor 420 can allocate an available parking space (destination) to the vehicle 100 based on the management information 450.

The management information 450 may include the position information of each vehicle 100 in the parking lot. The processor 420 may communicate with each vehicle 100 via the communication device 410 and collect the position information from each vehicle 100. Alternatively, the processor 420 may acquire the image captured by the infrastructure camera CAM installed in the parking lot and estimate the position of each vehicle 100 based on the image. The management information 450 may include the travel path TP allocated to each vehicle 100. The processor 420 can determine the travel path TP allocated to each vehicle 100 based on the position information of the vehicle 100, the destination, and the map information MAP. The processor 420 may provide the information on the travel path TP to the vehicle 100 via the communication device 410.

The management information 450 may include the vehicle management information VCL. The processor 420 may provide the function of the information provision system 500. More specifically, the processor 420 receives the request information REQ from the user terminal 200. In addition, the processor 420 receives information on the target time designated by the user from the user terminal 200. Moreover, the processor 420 generates the bird's-eye view image IMG based on the map information MAP and the vehicle management information VCL. Further, the processor 420 transmits the generated bird's-eye view image IMG to the user terminal 200.

### 7. CONFIGURATION EXAMPLE OF INFORMATION PROVISION SYSTEM

The information provision system 500 is configured to be able to share information with the user terminal 200. The information provision system 500 is able to receive a variety of requests from the user via the user terminal 200 and provide the user with a variety of information via the user terminal 200. For example, the information provision system 500 includes the back-end system 300. As another example, the information provision system 500 may include the parking lot system 400. As still another example, the information provision system 500 may include the user terminal 200 itself. In either case, the information provision system 500 is able to receive a variety of requests from the user and provide the user with a variety of information.

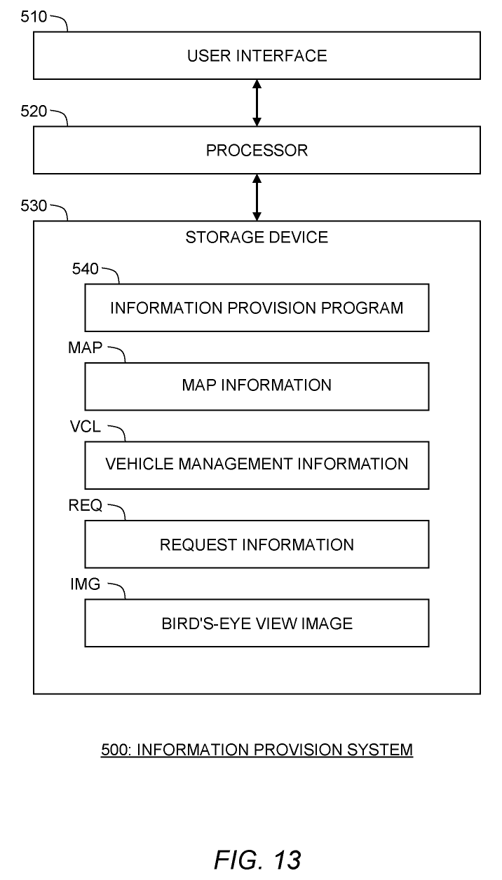

When generalized, the information provision system 500 has a configuration as shown in FIG. 13. The information provision system 500 includes a user interface 510, one or more processors 520 (hereinafter simply referred to as a processor 520), and one or more storage devices 530 (hereinafter simply referred to as a storage device 530).

The user interface 510 provides the user with information and receives information from the user. For example, the user interface 510 includes the communication device 310 (communication interface) of the back-end system 300. As another example, the user interface 510 may include the input device 220 and the display device 230 of the user terminal 200.

The processor 520 executes a variety of processing. Examples of the processor 520 include a general purpose processor, a special purpose processor, a CPU, a GPU, an ASIC, an FPGA, an integrated circuit, and / or combinations thereof. The processor 520 may also be referred to as processing circuitry. The storage device 530 stores a variety of information. Examples of the storage device 530 include a volatile memory, a nonvolatile memory, an HDD, an SSD, and the like.

An information provision program 540 is a computer program for the information provision process. The functions of the information provision system 500 may be realized by a cooperation between the processor 520 executing the information provision program 540 and the storage device 530. The information provision program 540 is stored in the storage device 530. The information provision program 540 may be recorded on a non-transitory computer-readable recording medium.

The memory device 530 stores the map information MAP and the vehicle management information VCL. The processor 520 receives the request information REQ from the user via the user interface 510. In addition, the processor 520 receives information on the target time designated by the user via the user interface 510. Moreover, the processor 520 generates the bird's-eye view image IMG based on the map information MAP and the vehicle management information VCL. Further, the processor 520 provides the user with the bird's-eye view image IMG via the user interface 510.

What is claimed is:

1. An information provision system applied to automated valet parking in a parking lot,
the information provision system comprising processing circuitry, wherein
the processing circuitry is configured to:
acquire vehicle management information including at least one of a record and a schedule of traveling and parking of each vehicle in the parking lot;
receive designation of a target time from a target user of a target vehicle;
generate, based on the vehicle management information, a bird's-eye view image showing a map of the parking lot and positions of the target vehicle and other vehicles in the parking lot at the target time with a bird's-eye view; and
provide the target user with the bird's-eye view image.

2. The information provision system according to claim 1, wherein
the processing circuitry is further configured to:
display a time seek bar together with the bird's-eye view image on a screen of a terminal operated by the target user; and
receive, as the target time, a time designated by an operation of the time seek bar on the screen.

3. The information provision system according to claim 1, wherein
the processing circuitry generates the bird's-eye view image such that the target vehicle is distinguishable from the other vehicles.

4. The information provision system according to claim 1, wherein
the processing circuitry is further configured to receive a reservation request for the automated valet parking in the parking lot from the target user,
an imaginary target vehicle is the target vehicle that assumptively travels and is parked in accordance with the reservation request,
the vehicle management information includes schedule information indicating the schedule of the traveling and the parking of the imaginary target vehicle and the other vehicles, and
the processing circuitry is configured to estimate, based on the schedule information, positions of the imaginary target vehicle and the other vehicles in the parking lot at the target time to generate the bird's-eye view image.

5. The information provision system according to claim 4, wherein
the processing circuitry is further configured to:
determine, based on the schedule information, whether there is a possibility of interference between the imaginary target vehicle and any of the other vehicles; and
when there is a possibility of interference between the imaginary target vehicle and any of the other vehicles, provide the target user with a reservation unavailable notification indicating that the reservation request is not acceptable.

6. The information provision system according to claim 5, wherein
the processing circuitry is further configured to receive a change of the reservation request from the target user.

7. The information provision system according to claim 6, wherein
the bird's-eye view image is displayed on a screen of a terminal operated by the target user,
a display position of the imaginary target vehicle on the screen is changeable by an operation performed by the target user, and
the processing circuitry is further configured to receive a change of the display position of the imaginary target vehicle on the screen as the change of the reservation request.

8. The information provision system according to claim 5, wherein
the processing circuitry is further configured to:
when there is a possibility of interference between the imaginary target vehicle and a first vehicle among the other vehicles, receive an adjustment request that requests for adjustment of the schedule of the first vehicle from the target user, and
determine, based on the schedule information, whether or not the schedule of the first vehicle is adjustable so as not to cause interference between the imaginary target vehicle and the first vehicle.

9. The information provision system according to claim 8, wherein
the bird's-eye view image is displayed on a screen of a terminal operated by the target user,
a display position of the first vehicle on the screen is changeable by an operation performed by the target user, and
the processing circuitry is further configured to receive a change of the display position of the first vehicle on the screen as the adjustment request.

10. An information providing method executed by a computer and applied to automated valet parking in a parking lot,
the information providing method comprising:
acquiring vehicle management information including at least one of a record and a schedule of traveling and parking of each vehicle in the parking lot;
receiving designation of a target time from a target user of a target vehicle;
generating, based on the vehicle management information, a bird's-eye view image showing a map of the parking lot and positions of the target vehicle and other vehicles in the parking lot at the target time with a bird's-eye view; and
providing the target user with the bird's-eye view image.
